(19) United States
(12) Patent Application Publication
(10) Pub. No.: US 2023/0413817 A1
(43) Pub. Date: Dec. 28, 2023

(54) CONTROLLING THE GROWTH OF VEGETATION

(71) Applicant: Bionome Technology Limited, London (GB)

(72) Inventors: Dennis McCarthy, London (GB); John Clearwater, Auckland (NZ)

(73) Assignee: Bionome Technology Limited, London (GB)

(21) Appl. No.: 17/907,219

(22) PCT Filed: Mar. 25, 2021
(86) PCT No.: PCT/GB2021/050727

§ 371 Date: Sep. 23, 2022

(30) Foreign Application Priority Data
Mar. 25, 2020 (GB) 2004292.5

(51) Int. Cl. A01N 43/16; A01N 25/02; A01N 25/30; A01N 43/80; A01N 37/44; A01N 43/88; A01N 43/08; A01N 31/02; A01P 13/00; A01N 65/08; A01N 65/12

(52) U.S. Cl. CPC A01N 43/16; A01N 25/02; A01N 25/30; A01N 43/80; A01N 37/44; A01N 43/88; A01N 43/08; A01N 31/02; A01P 13/00; A01N 65/08; A01N 65/12

(57) ABSTRACT

A method for controlling the growth of vegetation includes a step of applying a composition to the foliage of the vegetation, without any pre-heating. The application of the composition induces osmosis on cells of the foliage and destroys those cells. The composition includes an aqueous solution of at least one sugar, and optionally further includes a penetrant and an additional component such as a fatty acid. The sugar may be selected from natural plant-based sugars, sugar substitutes and sugar alcohols. The concentrations of the active ingredients may be varied to give either a weed-killing effect, or a plant growth inhibitor effect, as desired.

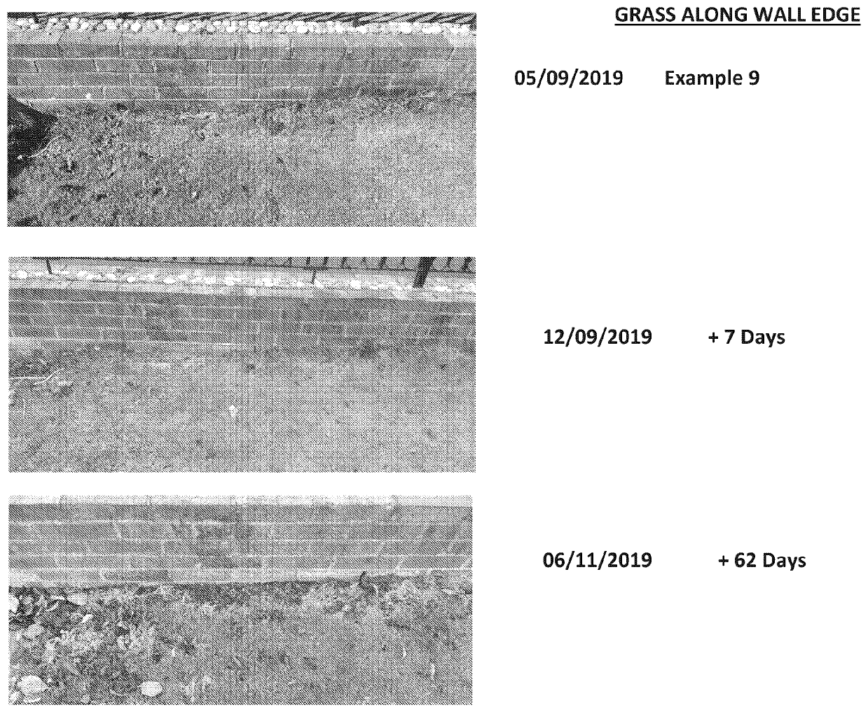

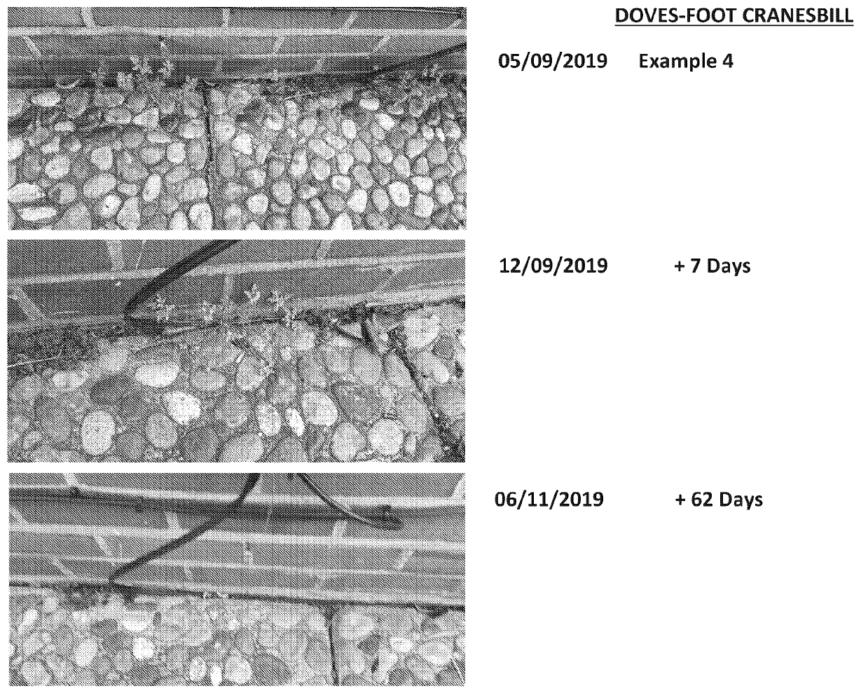

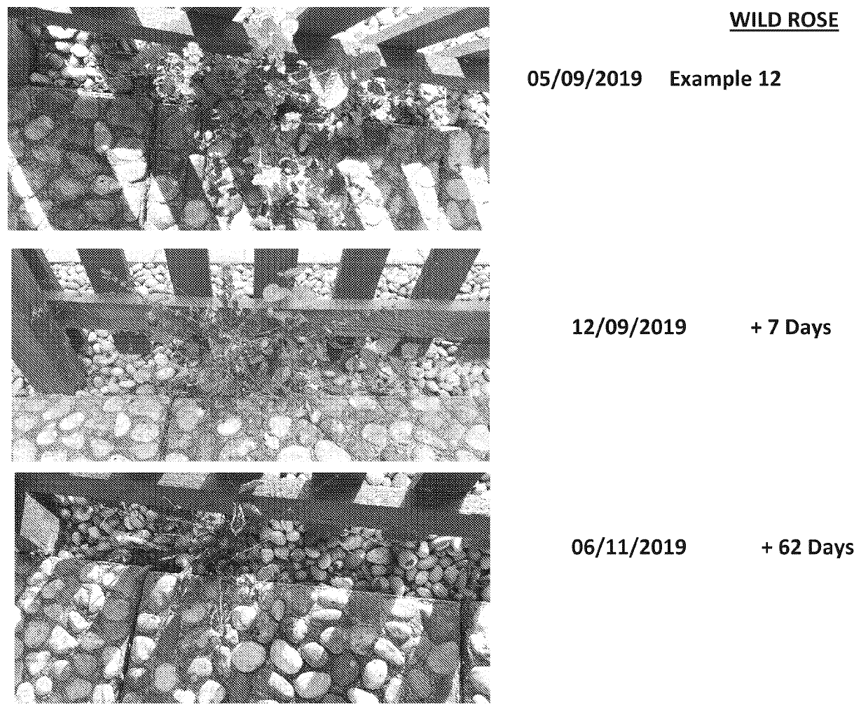

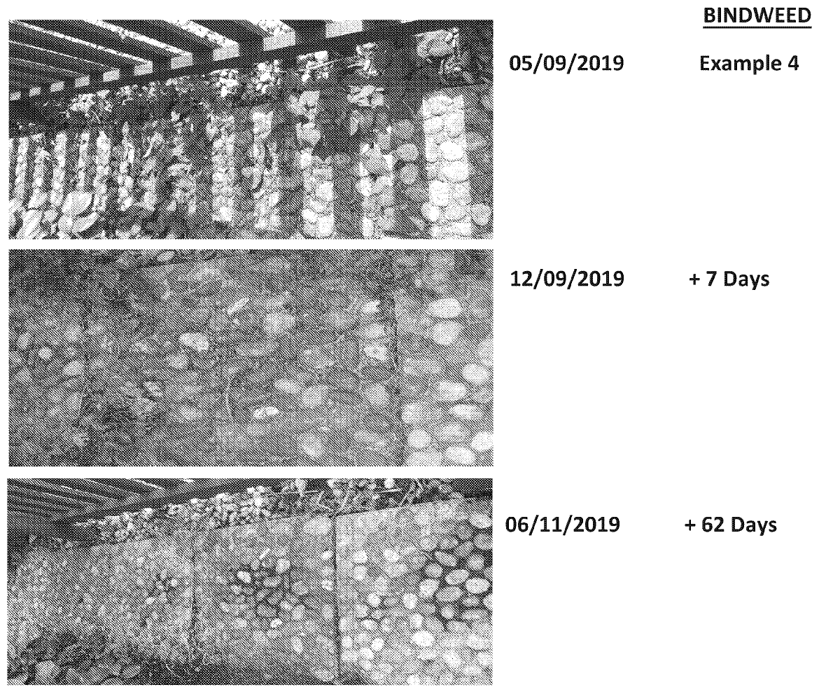

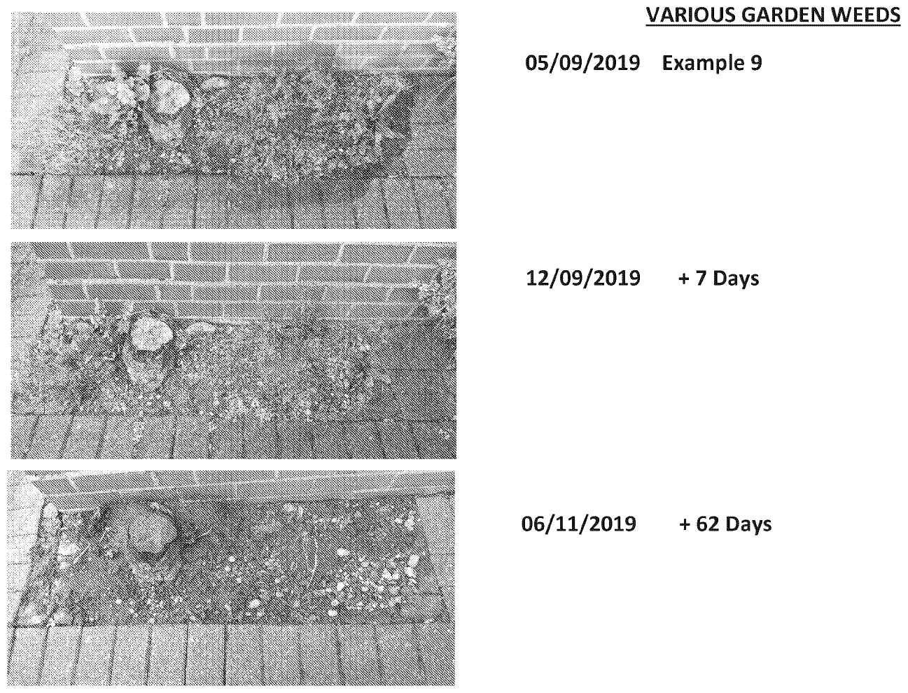

This invention relates to methods for the control of the growth of vegetation, and also to compositions, and the use thereof, for the control of the growth of vegetation. In particular, the invention concerns environmentally friendly methods having the aim of controlling or killing unwanted vegetation, or weeds.

The growth of vegetation in unwanted places can be controlled by physically uprooting the weeds, but this is both time consuming and labour intensive. Weeds are typically controlled by the topical application of chemicals, usually referred to as weedkillers, either by spraying a solution of the chemical on to the unwanted vegetation or by sprinkling the chemical in powder or granule form on to and around the weeds. The use of chemical weedkillers has been recognised as environmentally unacceptable, as causing lasting damage to the environment and especially also to wildlife, insects and micro-organisms which may be present in the vicinity of the weeds. As such, there is a strong demand for more environmentally acceptable weed control methods.

It has been proposed to kill weeds by burning them with a suitably designed flame gun, but clearly there is a fire risk associated with this method, and a risk of contamination of the soil with the fuel if the flame gun uses paraffin or other hydrocarbon liquid fuel. WO94/26102 discloses a method of controlling weeds by spraying the unwanted growth with a jet of pressurised hot water, typically in the range of 100 to 110° C. and at a pressure in the range of 200 to 1000 psi (about 13.75 to 69 bar). The generation of such temperatures and pressures is difficult and energy inefficient, especially if a large area is to be treated. Moreover, it is found that if the temperature of the jet impinging on the vegetation falls too quickly, the weeds are merely set back and can recover.

In an attempt to address the above problem, it has been proposed to apply the hot water in the form of a foam which will both stay on the foliage and provide a thermally insulating blanket, to keep the heat of the sprayed water on the foliage. Such a method is described in WO0207513 (Waipuna International Limited), wherein the foam blanket is generated by adding a foaming agent such as alkyl polyglucoside (APG) to the water, heating the water to a temperature at or near the boiling point of the water and then spraying the heated water in such a way that hot foam is deposited on the vegetation.

There is no exact definition of the foaming agent used in the method of WO0207513, though mention is made of the use of a “plant sugar extract”. WO0207513 further indicates that “trials are continuing to reduce the actual content of the plant sugars and replace with natural polymers”. This is because it is known that many plant sugar extracts become unstable at elevated temperatures, and so alternative foaming agents would be preferable for replacing the plant sugar extract. APG is the preferred foaming agent as it is able to withstand the high temperature needed to kill the plants.

The term “sugar” has no exact definition, but generally is used to mean sweet-tasting, soluble carbohydrates. The term “sugar” is used herein to refer to one or more of natural sugar, sugar substitutes and sugar alcohol.

The term “natural sugar” is used herein to refer to mono- or di-polysaccharides comprising a molecular chain of CHO.

The term “sugar substitute” is used herein to refer to those products that have a substantially increased sweeter taste than a natural sugar, but which are not categorised or chemically defined as a natural sugar. Sugar substitutes can be from natural plant sources or can be chemically formulated and defined as a laboratory-produced product, such as saccharin. Sugar substitutes may also be referred to commercially as sweeteners, intense sweeteners or bulk sweeteners.

The term “sugar alcohol” is used herein to refer to an organic compound (also called polyhydric alcohol, polyalcohol, alditol or glycitol) usually derived from natural sugars and containing one hydroxyl group (—OH) attached to each carbon atom.

According to one aspect of this invention, there is provided a method for controlling the growth of vegetation, comprising applying to the foliage of the vegetation, without any pre-heating, a composition comprising an aqueous solution of at least one sugar, thereby to induce osmosis on cells of the foliage and destroy those cells. The terms “composition” and “solution” as used herein should be understood such that the solution is a component of the composition as a whole. Thus, whilst the sugar component is in solution, other components may be present in the composition either in solution, or in some other form of mixture with the water in the composition such as suspension, dispersion, emulsion, etc.

This method can be contrasted with that of WO0207513 in that the sugar used in this invention is absolutely fundamental to the vegetation growth-controlling process, by inducing osmosis on the cells of the plant and of the foliage in particular. Further, the method is performed without heating the composition—it is applied to the vegetation (preferably by spraying) at or near ambient temperature. Were the composition to be heated, but depending on the sugar used, there would be a probability that the sugar could be partly destroyed, so reducing the effectiveness of the method. By contrast, in the method of WO0207513, the plant sugar extract plays no part in the vegetation controlling function; the sole purpose of the plant sugar extract is to enable the production of a foam to retain the hot water on the vegetation and serve as a thermally insulating blanket.

The use of an osmosis-inducing agent causes water within the cells of the plant vegetation to cross the cell's walls, thus inducing plasmolysis—that is, contraction of the protoplast of each affected cell as a result of the loss of water from the cell. This rapidly leads to death of the cells of the vegetation to which the composition has been applied.

Tests conducted on performing the method of this invention have shown that plant die-back proceeds rapidly after the application of the composition to the vegetation. Even with perennial weeds usually regarded as difficult to eradicate, most often the entire plant then dies with, in most cases, no regrowth from the roots. It is not entirely clear why the plant so comprehensively dies, but empirical tests have shown that this most often seems to be the case, even with “difficult” weeds such a bindweed and dandelion.

A further advantage of the performance of the invention is that a sugar solution is not in any way toxic to the environment. Any run-off from the foliage might affect plants growing at ground level under the vegetation to be controlled, by way of osmosis on those plants, but apart from that there is no harmful effect, and particularly not to insects or other fauna. In addition, any run-off can be beneficial to micro-organisms which improve soil quality.

The sugar used to make the solution for performing the method of this invention may comprise at least one plant-based natural sugar as defined herein. Alternatively, or additionally, the sugar may comprise at least one sugar substitute, also as defined herein. Further alternatively, or additionally, the sugar may comprise at least one sugar alcohol as defined herein.

Where the solution comprises at least one plant-based natural sugar, said plant-based natural sugar is preferably selected from the group consisting of sucrose, glucose, fructose, galactose, maltose, arabimose, lactose, inositol, mannose, ribose, trehalose, and xylose.

Where the solution comprises at least one sugar substitute, said sugar substitute is preferably selected from the group consisting of saccharin, sodium saccharin, stevia rebaudiana, siraitia grosvenori, aspartame, acesulfame potassium, sucralose, neotame, and advantame.

Where the solution comprises at least one sugar alcohol, said sugar alcohol is preferably selected from sorbitol, xylitol, lactitol, mannitol, erythritol, and maltitol.

Enhanced vegetation control may be obtained by making a solution which contains two or more sugars selected from the group consisting of natural sugar, sugar substitute and sugar alcohol.

Most preferably, the sugar solution comprises sodium saccharin, and optionally also a plant-based natural sugar.

The rate of application of the composition to the foliage is best determined empirically, having regard to the nature of the plants to be treated. Consideration should be given to the density of the vegetation, the foliage of that vegetation, the vigorousness and establishment of the vegetation, the height of the plants and other relevant factors. Typically, for weeds growing in unwanted places, the composition may be sprayed at a rate sufficient to wet the majority, if not all, the foliage of the plant.

Similarly, the sugar content of the solution may give a concentration in the range of from 50 to 133 g/l, and preferably substantially 100 g/l of the solution. However, reduced ratios of the active ingredient (sugar) will produce a plant growth inhibitor reaction which can be of benefit to agricultural producers.

The performance of the composition at causing osmosis in the foliage may be enhanced by including a penetrant, which is able to promote the osmotic action of the solution. A “penetrant” is used herein to refer to a biochemical agent used with an agrichemical to cause a plant to absorb, or to increase the absorbance of, the agrichemical (in this case, the solution of natural sugar or sugar substitute) in a more effective manner and so succumb more readily to the osmotic action of the composition. The penetrant may be most effective when used against plants that would otherwise be able to resist the composition. Often such plants have tough or shiny leaves that are capable of easily shedding the composition.

A widely used penetrant in the agrichemical industry is sold under the registered trade mark Validate® by De Sangosse Limited. The Validate® product comprises a penetrating and translocating wetting agent and adjuvant, comprising an emulsifiable concentrate formulation containing 50.0% w/w soybean phospholipid, 25.0% w/w alkoxylated alcohols and 25.0% w/w oil (soybean fatty acid esters).

Other penetrants besides Validate® may be used, such as alkyl polyglucoside (APG), or Yucca extract, such penetrants typically comprising one or more of a surfactant, a wetting agent and an adjuvant.

The penetrant may be present in the solution in an amount in the range of from 0.15% to 0.5%, and preferably 0.375%, by volume, relative to the volume of water.

The composition may preferably further comprise a bactericide, to prevent bacteria growth over time within the composition during storage.

The composition may further comprise one more additional components selected from citric acid, a fatty acid, and an essential oil. Most preferably, the additional component is or comprises a fatty acid.

Such additional components may be mixed together with the sugar solution to form the composition either during a manufacturing process, or at the point of applying the composition to vegetation, commonly referred to as a “tank mix” process. In such a process, the sugar solution and additional components may be mixed together in a substantially 50:50 ratio.

Where one or more essential oils is present, said essential oil is preferably selected from the group consisting of pine oil, manuka oil and tea tree oil.

Wherein one or more fatty acids is present, said fatty acid is preferably selected from pelargonic acid, acetic acid and caprylic acid. Most preferably, said fatty acid is or comprises pelargonic acid.

The fatty acid may be present in the composition in an amount in the range of from 9% to 17%, and preferably substantially 9%, by volume relative to the volume of water.

The reduced levels of fatty acid described above, optionally in combination with reduced levels of the active sugar component, are particularly preferred when the compositions of the present invention are intended to be used for plant growth regulation, by promoting a plant growth inhibitor effect, as opposed to intending to eradicate a target plant entirely.

This invention extends to compositions as herein defined comprising a solution of at least one sugar, and to the use of such compositions in a method as hereinbefore described for controlling the growth of vegetation, comprising applying the composition without pre-heating to foliage of the vegetation thereby to induce osmosis on cells of the foliage and cause destruction of those cells.

In order that the invention may better be understood, it will now be described in more detail and certain specific examples thereof given, by way of illustration of the methods of controlling the growth of vegetation. In the following, reference will be made to the accompanying tables, and photographs, in which:

Table 1 lists various natural sugars which can be used in performing this invention, along with the origin of those sugars;

Table 2 lists various high intensity sugars which can be used in performing this invention, all of which are chemically synthesised except for stevia (stevia rebaudiana) and siraitia grosvenori, both of which are extracted from plants;

Table 3 lists various sugar alcohols which can be used in performing this invention, along with the origin of those sugars;

Table 4 sets out the formulations of various compositions used to control the growth of vegetation, along with control compositions (Examples 1 to 3) for comparative purposes, and the results obtained with the compositions; and

Table 5 sets out the formulations of various compositions with additional components, used to control the growth of vegetation, along with control compositions (Examples 13 and 14) for comparative purposes, and the results obtained with the compositions in further trials.

In order to test the methods of this invention several trials of sugar-containing compositions were conducted on a broad spectrum of plants commonly regarded as weeds, including creeping buttercup, grasses, dandelion, bindweed, common sorrel, fat hen, amaranth, field forget-me-not and so on. The composition formulations and results of the trials are set out in Table 4. In Table 4, ‘0’ in the “Days after application” columns indicate zero phytotoxicity action, and ‘10’ indicates an excellent performance with 100% plant killing. In each case, the compositions were applied to the plants by spraying at a rate sufficient to wet the foliage of the plants, this being assisted by the use of a penetrant and, in some cases, the use of APG.

Referring primarily to Table 4, APG is alkyl polyglucoside, a non-ionic surfactant. APG has been used in commercial applications of the method of WO94/26102, to assist in the application of the hot foam of that method to the foliage of plants. The inclusion of APG in the trials of this invention was to confirm that APG did not cause degradation of plant life in a cold water solution—i.e. that it did not take part in the method of controlling the growth of vegetation.

Validate® is as has been defined hereinbefore; again, its inclusion in the trials of this invention was to confirm that Validate did not cause degradation of plant life in a cold water solution—i.e. that it did not take part in the method of controlling the growth of vegetation.

Yucca is an extract from the yucca plant; extracts from certain species are high in saponin content and so widely used as a natural surfactant or wetting agent.

Except for Examples 1 to 3 (APG alone, Validate® alone and Yucca alone), the compositions of Table 4 were made up by mixing with water a weight of natural sugar and/or sugar substitutes with a surfactant/spreader/penetrant, all as shown in the various columns of Table 4.

Except for Examples 1 to 3 (APG alone, Validate® alone and Yucca alone) where no phytotoxicity was observed, the result of application of the compositions by spraying across a broad spectrum of weeds indicate the ‘physical’ mode of action of the sugar content, being that of plasmolysis, which exceeds the performance of other weedkillers such as glyphosate (e.g. Roundup®).

Example 4 comprises 100 g of sodium saccharin and 2.5 ml of Validate® mixed into 1000 ml of water. As can be seen, after 42 days the plant was killed with no re-growth even after 189 days.

Example 5 comprises 50 g of sodium saccharin and 50 g of stevia, together with 1.5 ml of APG, mixed into 1000 ml of water. As can be seen, though there was an initial reaction, after 42 days the plant largely recovered.

Example 6 comprises 100 g of stevia and 7.5 ml of yucca, mixed into 2000 ml of water. As can be seen, there was an initial reaction building to a maximum after 42 days, but then some re-growth occurred.

Example 7 comprises 100 g of natural sugar and 50 g of stevia together with 7.5 ml of yucca, mixed into 2000 ml of water. As can be seen, there was only limited phytotoxicity to the plants treated with this composition.

Example 8 comprises 100 g of natural sugar, 50 g of stevia and 5 ml of Validate mixed into 2000 ml of water. As can be seen, there was only limited toxicity to the plants treated with this composition, though a better performance than Example 7.

Example 9 comprises 100 g of sodium saccharin and 5 ml of Validate mixed into 2000 ml of water. As can be seen, after 42 days the plant was killed with no re-growth even after 189 days.

Example 10 comprises 75 g of sodium saccharin, 125 g of natural sugar and 10 ml of yucca mixed into 2000 ml of water. As can be seen, there was only limited phytotoxicity to the plants treated with this composition.

Example 11 comprises 50 g of sodium saccharin, 150 g of stevia and 2.5 ml of AGP mixed into 1500 ml of water. As can be seen, this composition had essentially no toxicity on the plants to which it was applied.

Example 12 comprises 75 g of sodium saccharin, 125 g of natural sugar and 7.5 ml of Validate mixed into 2000 ml of water. As can be seen, after 42 days the plant was killed with no re-growth even after 189 days.

From the results of the above trials, it will be appreciated that APG had no effect as an active ingredient in controlling the growth of plants (Example 1). Equally, when mixed with Validate there was no effect as an active ingredient in controlling the growth of plants (Example 2). By contrast, the use of sugar substitutes (sodium saccharin and stevia) together with Validate produced outstanding results in all mixture ratios.

Natural sugar alone at the ratios applied did not provide commercial acceptable results. Validate as a surfactant and penetrant provided best results in all Examples when compared to yucca. The action of yucca was inferior in all trials to that of Validate.

In the trials, it has been observed that on treating many perennial species there has been “translocation” resulting in complete destruction of the root system of the weeds. Thus, it seems that the osmotic action of the applied sugar has been carried down to the root system, and is not active solely on the foliage on to which the composition has been sprayed. This suggests the “mode of action” of this invention is one of foliar stimulated “plasmolysis” which then has a secondary effect by either shutting down ‘osmotic action’ at the root of the plant (preventing the drawing of water into the plant) or some other translocating activity generated by the destruction of the foliage.

This can be contrasted with other contact methods of controlling the growth of vegetation, such as the use of paraquat and heat thermal treatments (such as in WO0207513) where limited die back has been observed.

Accompanying this specification are five sheets of photographs, each sheet carrying three photographs of a treated area. On each sheet, the plants (generally regarded as weeds) were treated with the specified compositions of Table 4, and photographed at the time of application, 7 days later and again 62 days later. As can be seen, complete killing of the weeds was achieved with Examples 4, 9 and 12.

Referring now to Table 5, further trials were carried out using compositions comprising a preferred sugar component, namely sodium saccharin, and a preferred additional component, namely pelargonic acid. Trials were carried out to observe potential benefits on weed kill of mixing these active ingredients, during the November/December winter season.

Example 13 is a control composition comprising pelargonic acid only, at the manufacturer's recommended concentration of 85 ml in 500 ml of water. As can be seen, the efficacy score, observed 15 days after application on the same scale as hereinbefore described, was 3.

Example 14 is a control composition comprising sodium saccharin only, at the manufacturer's recommended concentration of 100 g in 1000 ml of water. As can be seen, the efficacy score, observed 15 days after application on the same scale as hereinbefore described, was 2.

Example 15 comprises 100 g of sodium saccharin and 180 ml of pelargonic acid, together with 5 ml of Validate®, in 2000 ml of water. The concentrations of both active ingredients are therefore substantially 50% of the recommended level. As can be seen, the efficacy score, observed 15 days after application on the same scale as hereinbefore described, was 7.

Example 16 comprises 100 g of sodium saccharin and 340 ml of pelargonic acid, together with 5 ml of Validate®, in 2000 ml of water. The concentration of sugar is therefore substantially 50% of the recommended level, whilst the concentration of fatty acid is at the recommended level. As can be seen, the efficacy score, observed 15 days after application on the same scale as hereinbefore described, was again 7.

Example 17 comprises 200 g of sodium saccharin and 180 ml of pelargonic acid, together with 5 ml of Validate®, in 2000 ml of water. The concentration of sugar is therefore at the recommended level, whilst the concentration of fatty acid is substantially 50% of the recommended level. As can be seen, the efficacy score, observed 15 days after application on the same scale as hereinbefore described, was again 7.

In conclusion, neither active ingredient alone produces a satisfactory result. Both active ingredients together however do provide a satisfactory result, even when the concentration on one of both active ingredients is reduced to 50% of the recommended level. There appears to be a synergistic effect between the two active ingredients.

TABLE 1
Natural sugars

| | | | |
|---|---|---|---|
| Sucrose | Disacc | C₁₂H₂₂O₁₁ | Sugar Beet & Sugar Cane |
| | Table Sugar | | |
| Glucose | Mono | C₆H₁₂O₆ | Honey, Fruits, Vegetables |
| Fructose | Mono | C₆H₁₂O₆ | Fruits, Honey |
| Galactose | Mono | C₆H₁₂O₆ | Milk, Dairy |
| Maltose | Disacc | C₁₂H₂₂O₁₁ | Barley |
| Arabimose | Mono | C₅H₁₀O₅ | Pectin, hemicellulose |
| Lactose | Disacc | C₁₂H₂₂O₁₁ | Milk, also made from |
| | | | Glucose & Galactose |
| Inositol | Mono | C₆H₁₂O₆ | Cantaloupe, citrus, beans, rice etc |
| Mannose | Mono | C₆H₁₂O₆ | Fruit, Mammalian Plasma |
| Ribose | Mono | C₅H₁₀O₅ | A Glucose to pentose phosphate |
| Trehalose | Disacc | C₁₂H₂₂O₁₁ | Mushrooms, honey, seafood |
| Xylose | Mono | C₅H₁₀O₅ | Wood, Straw |

TABLE 2
High Intensity Sweeteners

| | | |
|---|---|---|
| Saccharin | C₇H₅NO₃S | Laboratory produced |
| Aspartame | C₁₄H₁₈N₂O₅ | Aspartic & phenylalamine |
| | | amino acids |
| Acesulfame Potassium | C₄H₄KNO₄ | Acetoacetic acid |
| Sucralose | C₁₂H₁₉C₁₃O₈ | Sugar plus chemical process |
| Neotame | C₂₀H₃₀N₂O₅ | Aspartame and additives |
| Advantame | C₂₄H₃₀N₂O₇ | Aspartame and Vanillin |
| Stevia | Various | Stevia rebaudiana |
| Siraitia Grosvenorii | Various | Monk fruit China |

Saccharin: 1,2-benzisothiazol-3(2H)-one 1,1-dioxide.

TABLE 3
Sugar Alcohols

| | | |
|---|---|---|
| Sorbitol | C₆H₁₄O₆ | From glucose |
| Xylitol | C₅H₁₂O₅ | Plants, fruit, vegetables |
| Lactitol | C₁₂H₂₄O₁₁ | Milk sugar |
| Mannitol | C₆H₁₄O₆ | Plants, fructose |
| Erythritol | C₄H₁₀O₄ | Fruits, corn |
| Maltitol | C₁₂H₂₄O₁₁ | Wheat, tapioca, corn, starches |

TABLE 4
Trial Results

| | | | | Days after Application | | | | | | |
|---|---|---|---|---|---|---|---|---|---|---|
| Eg | Product | Penetrant | H₂O | 3 | 7 | 14 | 42 | 79 | 136 | 189 |
| 1 | APG 200 ml | Zero | 1000 ml | 0 | 0 | 0 | 0 | 0 | 0 | 0 |
| 2 | APG 200 ml | Validate 2.5 ml | 1000 ml | 0 | 0 | 0 | 0 | 0 | 0 | 0 |
| 3 | APG 200 ml | Yucca 7.5 ml | 1000 ml | 0 | 0 | 0 | 0 | 0 | 0 | 0 |
| 4 | Sodium saccharin 100 g | Validate 2.5 ml | 1000 ml | 4 | 6 | 7 | 10 | 10 | 10 | 10 |
| 5 | Sodium saccharin 50 g | APG 1.5 ml | 1000 ml | 1 | 2 | 2 | 3 | 0 | 0 | 0 |
| | Stevia 50 g | | | | | | | | | |
| 6 | Stevia 100 g | Yucca 7.5 ml | 2000 ml | 2 | 4 | 5 | 6 | 5 | 3 | 3 |
| 7 | Natural sugar 100 g | Yucca 7.5 ml | 2000 ml | 1 | 3 | 3 | 2 | 2 | 2 | 2 |
| | Stevia 50 g | | | | | | | | | |
| 8 | Natural sugar 100 g | Validate 5 ml | 2000 ml | 2 | 4 | 4 | 3 | 3 | 3 | 3 |
| | Stevia 50 g | | | | | | | | | |
| 9 | Sodium saccharin 100 g | Validate 5 ml | 2000 ml | 3 | 5 | 7 | 10 | 10 | 10 | 10 |
| 10 | Sodium saccharin 75 g | Yucca 10 ml | 2000 ml | 1 | 3 | 4 | 4 | 2 | 2 | 2 |
| | Natural sugar 125 g | | | | | | | | | |
| 11 | Sodium saccharin 50 g | APG 2.5 ml | 1500 ml | 1 | 2 | 2 | 1 | 0 | 0 | 0 |
| | Stevia 150 g | | | | | | | | | |
| 12 | Sodium saccharin 75 g | Validate 7.5 ml | 2000 ml | 5 | 7 | 8 | 10 | 10 | 10 | 10 |
| | Natural sugar 125 g | | | | | | | | | |

TABLE 5
Trial Results with Additional Component

| | | | | | Days after application |
|---|---|---|---|---|---|
| Eg | Product | Penetrant | Component | H₂O | 15 |
| 13 | Zero | Zero | Pelargonic acid 85 ml | 500 ml | 3 |
| 14 | Sodium saccharin 100 g | Zero | Zero | 1000 ml | 2 |
| 15 | Sodium saccharin 100 g | Validate 5 ml | Pelargonic acid 180 ml | 2000 ml | 7 |
| 16 | Sodium saccharin 100 g | Validate 5 ml | Pelargonic acid 340 ml | 2000 ml | 7 |
| 17 | Sodium saccharin 200 g | Validate 5 ml | Pelargonic acid 180 ml | 2000 ml | 7 |

1. A method for controlling the growth of vegetation, comprising applying to the foliage of the vegetation, without any pre-heating, a composition comprising an aqueous solution of at least one sugar, thereby to induce osmosis on cells of the foliage and destroy those cells.

2. The method as claimed in claim 1, wherein the sugar comprises at least one plant-based natural sugar.

3. The method as claimed in claim 2 wherein said at least one plant-based natural sugar is selected from the group consisting of sucrose, glucose, fructose, galactose, maltose, arabimose, lactose, inositol, mannose, ribose, trehalose, and xylose.

4. The method as claimed in claim 1, wherein the sugar comprises at least one sugar substitute.

5. The method as claimed in claim 4, wherein said at least one sugar substitute is selected from the group consisting of saccharin, sodium saccharin, stevia rebaudiana, siraitia grosvenori, aspartame, acesulfame potassium, sucralose, neotame, and advantame.

6. The method as claimed in claim 1, wherein the sugar comprises at least one sugar alcohol.

7. The method as claimed in claim 6, wherein said at least one sugar alcohol is selected from the group consisting of sorbitol, xylitol, lactitol, mannitol, erythritol, and maltitol.

8. The method as claimed in claim 1, wherein the solution comprises at least two sugars selected from the group consisting of natural sugar, sugar substitute and sugar alcohol.

9. The method as claimed in claim 1, wherein the sugar comprises sodium saccharine.

10. The method as claimed in claim 1, wherein the solution has a sugar concentration in the range of from 50 to 133 g/l.

11. (canceled)

12. The method as claimed in claim 1, wherein the composition further comprises a penetrant to promote the osmotic action of the solution.

13. The method as claimed in claim 12, wherein the penetrant comprises at least one component selected from the group consisting of a surfactant, a wetting agent and an adjuvant.

14. The method as claimed in claim 12, wherein the penetrant is selected from the group consisting of alkyl polyglucoside (apg), Validate® and Yucca extract.

15. (canceled)

16. The method as claimed in claim 12, wherein the penetrant is present in the solution in an amount in the range of from 0.15% to 0.5% by volume, relative to the volume of water.

17. (canceled)

18. The method as claimed in claim 1, wherein the composition comprises at least one additional component selected from the group consisting of citric acid, a fatty acid, and an essential oil.

19. The method as claimed in claim 18, wherein the essential oil comprises at least one essential oil selected from pine oil, manuka oil and tea tree oil.

20. (canceled)

21. The method as claimed in claim 18, wherein the fatty acid comprises at least one fatty acid selected from pelargonic acid, acetic acid and caprylic acid.

22. (canceled)

23. The method as claimed in claim 18, wherein the composition comprises substantially 50% sugar solution and substantially 50% fatty acid.

24. The method as claimed in claim 20, wherein the fatty acid is present in the composition in an amount of substantially 9% by volume relative to the volume of water.

25. The method as claimed in claim 1, in which the composition is applied by spraying at ambient temperature, at a rate sufficient to wet the majority of the foliage of the plant being treated.

26. (canceled)

27. (canceled)

28. (canceled)

29. (canceled)

30. (canceled)
